(19) United States
(12) Patent Application Publication
(10) Pub. No.: US 2024/0303125 A1
(43) Pub. Date: Sep. 12, 2024

(54) METHOD AND SYSTEM FOR CREATING OPERATION CALL LIST FOR ARTIFICIAL INTELLIGENCE CALCULATION

(71) Applicant: MOREH CORP., Seoul (KR)

(72) Inventors: Gangwon Jo, Seoul (KR); Jungho Park, Seoul (KR)

(21) Appl. No.: 18/418,994

(22) Filed: Jan. 22, 2024

(30) Foreign Application Priority Data
Mar. 6, 2023 (KR) 10-2023-0029483
Jul. 7, 2023 (KR) 10-2023-0088285

(51) Int. Cl. G06F 9/50; G06F 11/34

(52) U.S. Cl. CPC G06F 9/5038; G06F 11/3466

(57) ABSTRACT

Provided is a method for creating an operation call list for artificial intelligence calculation, which is performed by one or more processors, and includes acquiring a trace from a source program including an artificial intelligence calculation, wherein the trace includes at least one of code or primitive operation associated with the source program, and creating a call list including a plurality of primitive operations based on the trace, in which the plurality of primitive operations may be included in an operation library accessible to each of the plurality of accelerators.

### CROSS-REFERENCE TO RELATED APPLICATIONS

This application claims priority under 35 U.S.C § 119 to Korean Patent Application No. 10-2023-0029483, filed in the Korean Intellectual Property Office on Mar. 6, 2023, and No. 10-2023-0088285, filed in the Korean Intellectual Property Office on Jul. 7, 2023, the entire contents of which are hereby incorporated by reference.

### TECHNICAL FIELD

The present disclosure relates to a method for creating an operation call list, and more specifically, to a method and system for creating an operation call list including at least one primitive operation for artificial intelligence calculation.

### BACKGROUND

An application programmer who writes a deep learning application may create a source code combining a plurality of calculations using a deep learning framework (e.g., TensorFlow). The source code may be implemented by utilizing operations included in operation libraries (e.g., Nvidia's cuDNN, Intel's MKL-DNN, etc.) distributed by hardware manufacturers.

The source code implemented with the artificial intelligence program is compiled and converted into binary code through a processor, and the processor executes the binary code to perform an operation associated with the artificial intelligence calculation.

Meanwhile, the compiled binary code can operate normally only in a designated type of processor. For example, a binary code compiled by a first accelerator provided by a specific manufacturer may normally operate only in the first accelerator, but may not normally operate in a second accelerator provided by another manufacturer.

Meanwhile, a computing system including mass storage resources capable of simultaneously processing complex artificial intelligence calculations is built, and various types of artificial intelligence calculations are simultaneously processed through such a computing system. This computing system including the mass storage resources may include various types of processors. For example, processors associated with various manufacturers, such as a first accelerator provided by a first manufacturer, a second accelerator provided by a second manufacturer, a third processor provided by a third manufacturer, and so on may be included in the computing system.

In this computing system including various types of processors as described above, compiling in a related manner may result in creation of a binary code dependent on a specific type of processor. Accordingly, there is a demand for a compilation technology that is universally applicable to various types of processors without depending on a specific type of processor.

### SUMMARY

In order to solve the problems described above, the present disclosure provides a method, a computer program stored in a computer readable recording medium, a computer readable recording medium, and an apparatus (system) for creating an operation call list for artificial intelligence calculation.

The present disclosure may be implemented in a variety of ways, including methods, apparatus (systems) and/or computer programs stored on computer readable storage media.

A method for creating an operation call list for artificial intelligence calculation is provided, which may be performed by one or more processors and include acquiring a trace from a source program including an artificial intelligence calculation, the trace includes at least one of code or primitive operation associated with the source program, and creating a call list including a plurality of primitive operations based on the trace, in which the plurality of primitive operations may be included in an operation library accessible to each of the plurality of accelerators.

In addition, the acquiring the trace may include acquiring at least one of the code or primitive operation associated with the artificial intelligence calculation by executing the source program, and acquiring the trace including the acquired at least one code or primitive operations. In addition, the creating the call list may include determining a correlation for each of the plurality of primitive operations, and creating the call list including the correlation for each of the determined plurality of primitive operations.

In addition, the correlation may be a relationship in which output data of a first primitive operation included in the call list is input to a second primitive operation included in the call list.

In addition, the creating the call list may include creating a graph representing a call order and a correlation of the plurality of primitive operations based on the plurality of primitive operations included in the call list.

In addition, the method may further include transmitting the created call list to at least one of a plurality of accelerators, and the accelerator may be configured to, upon receiving the call list, access the operation library and call the plurality of primitive operations included in the call list.

The method may further include creating a new call list based on the call list by applying the call list to at least one compiler pass.

In addition, the creating the new call list may include determining, from among the primitive operations included in the call list, a plurality of primitive operations to be merged based on identifiers of primitive operations, merging the determined plurality of primitive operations into one primitive operation, and creating the new call list by changing the call list to include the merged primitive operation.

In addition, the input data for each of the determined plurality of primitive operations may be input as a merged primitive operation.

In addition, the creating the new call list may include determining the number of the plurality of accelerators to be provided with the call list, dividing input data included in the call list based on the determined number of the plurality of accelerators, and creating the new call list by changing the call list to include the divided input data.

In addition, the creating the new call list may include determining the number of the plurality of accelerators to be provided with the call list, dividing the call list into a plurality of sub call lists based on the determined number of the plurality of accelerators, and creating the new call list by changing the call list such that the divided plurality of sub call lists are pipelined.

In addition, the method may further include, after the creating the new call list, transmitting the divided plurality of sub call lists to the plurality of accelerators, and the first accelerator receiving a first sub call list and the second accelerator receiving a second sub call list pipelined with the first sub call list may be included in the same node.

In addition, the creating the new call list may include inserting at least one command into at least one of the first sub call list or the second sub call list such that output data based on the first sub call list is provided as input data of a primitive operation included in the second sub call list.

In addition, the method may further include, after the creating the new call list, transmitting the divided plurality of sub call lists to the plurality of accelerators, and a first accelerator receiving a first sub call list may be included in a first node, and a second accelerator receiving a second sub call list pipelined with a first sub call list may be included in a second node, and the first node may be a neighboring node adjacent to the second node.

In addition, the creating the new call list may include determining the number of the plurality of accelerators to be provided with the call list, dividing a plurality of parameters applied to each of the primitive operations included in the call list based on the determined number of the plurality of accelerators, and creating a new call list by changing the call list to include the divided parameters.

In addition, the creating the new call list may include determining, from among the primitive operations included in the call list, a plurality of primitive operations to be merged based on at least one of data structure or identifier associated with the primitive operations, merging the determined plurality of primitive operations into one primitive operation, and creating the new call list by changing the call list to include the merged primitive operation.

In addition, the creating the new call list may include identifying, from among the plurality of primitive operations included in the call list, at least one independently performed primitive operation, changing an execution order of the identified at least one primitive operation, and creating a new call list by changing the call list to include the changed at least one primitive operation.

In addition, the changing the execution order of the identified at least one primitive operation may include changing the execution order of the at least one primitive operation such that the execution order of the identified at least one primitive operation is advanced.

There may be provided a computer-readable non-transitory recording medium recording instructions for causing performance of the method described above on a computer.

An information processing system is provided, which may include a memory, and one or more processors connected to the memory and configured to execute one or more computer-readable programs included in the memory, in which the one or more programs may further include instructions for acquiring a trace from a source program including an artificial intelligence calculation, the trace includes at least one of code or primitive operation associated with the source program, and creating a call list including a plurality of primitive operations based on the trace, in which the plurality of primitive operations may be included in an operation library accessible to each of the plurality of accelerators.

According to some examples of the present disclosure, a call list including a plurality of primitive operations can be created based on a trace including code or primitive operations associated with an artificial intelligence calculation. A plurality of primitive operations included in the call list can be normally executed in various types of accelerators without depending on the accelerator type.

According to some examples of the present disclosure, while the artificial intelligence program is running (i.e., during runtime), a plurality of codes and/or primitive operations related to calculations can be extracted, and a trace including the plurality of extracted codes and/or primitive operations can be created. Based on the trace, all primitive operations essential for artificial intelligence calculations can be included in the call list completely.

According to some examples of the present disclosure, a call list can be optimized by applying the call list to one or more compiler passes. With the optimized call list, computing resources can be saved and calculation results can be output more quickly.

The effects of the present disclosure are not limited to the effects described above, and other effects not described herein can be clearly understood by those of ordinary skill in the art (referred to as “ordinary technician”) from the description of the claims.

### BRIEF DESCRIPTION OF THE DRAWINGS

The above and other objects, features and advantages of the present disclosure will be described with reference to the accompanying drawings described below, where similar reference numerals indicate similar elements, but not limited thereto, in which:

FIG. 1 is a schematic diagram illustrating a method for creating a call list;

FIG. 2 is a block diagram illustrating an internal configuration of an information processing system;

FIG. 3 is a block diagram illustrating an internal configuration of a processor;

FIG. 4 illustrates an example of a trace acquired from an artificial intelligence program;

FIG. 5 illustrates a call list;

FIG. 6 illustrates an example of a graph representation of a call list;

FIG. 7 illustrates a first call list passed through a first compiler pass and optimized into a second call list;

FIG. 8 illustrates a first call list passed through a second compiler pass and changed into a first sub call list and a second sub call list;

FIG. 9 illustrates a first call list passed through a third compiler pass and changed into a first sub call list and a second sub call list;

FIG. 10 illustrates a first call list passed through a third compiler pass and changed into first to fourth sub call lists;

FIG. 11 illustrates a first call list passed through a fourth compiler pass and changed into first and second sub call lists;

FIG. 12 illustrates a first call list passed through a fifth compiler pass and changed into a second call list;

FIG. 13 illustrates a first call list passed through a sixth compiler pass and changed into a second call list;

FIG. 14 is a flowchart illustrating a method for creating an operation call list; and

FIG. 15 is a flowchart illustrating a method for creating a new optimized call list by applying a call list to a compiler pass.

### DETAILED DESCRIPTION

Hereinafter, example details for the practice of the present disclosure will be described in detail with reference to the accompanying drawings. However, in the following description, detailed descriptions of well-known functions or configurations will be omitted if it may make the subject matter of the present disclosure rather unclear.

In the accompanying drawings, the same or corresponding components are assigned the same reference numerals. In addition, in the following description of various examples, duplicate descriptions of the same or corresponding components may be omitted. However, even if descriptions of components are omitted, it is not intended that such components are not included in any example.

Advantages and features of the disclosed examples and methods of accomplishing the same will be apparent by referring to examples described below in connection with the accompanying drawings. However, the present disclosure is not limited to the examples disclosed below, and may be implemented in various forms different from each other, and the examples are merely provided to make the present disclosure complete, and to fully disclose the scope of the disclosure to those skilled in the art to which the present disclosure pertains.

The terms used herein will be briefly described prior to describing the disclosed example(s) in detail. The terms used herein have been selected as general terms which are widely used at present in consideration of the functions of the present disclosure, and this may be altered according to the intent of an operator skilled in the art, related practice, or introduction of new technology. In addition, in specific cases, certain terms may be arbitrarily selected by the applicant, and the meaning of the terms will be described in detail in a corresponding description of the example(s). Therefore, the terms used in the present disclosure should be defined based on the meaning of the terms and the overall content of the present disclosure rather than a simple name of each of the terms.

As used herein, the singular forms “a,” “an,” and “the” are intended to include the plural forms as well, unless the context clearly indicates the singular forms. Further, the plural forms are intended to include the singular forms as well, unless the context clearly indicates the plural forms. Further, throughout the description, when a portion is stated as “comprising (including)” a component, it is intended as meaning that the portion may additionally comprise (or include or have) another component, rather than excluding the same, unless specified to the contrary.

Further, the term “module” or “unit” used herein refers to a software or hardware component, and “module” or “unit” performs certain roles. However, the meaning of the “module” or “unit” is not limited to software or hardware. The “module” or “unit” may be configured to be in an addressable storage medium or configured to play one or more processors. Accordingly, as an example, the “module” or “unit” may include components such as software components, object-oriented software components, class components, and task components, and at least one of processes, functions, attributes, procedures, subroutines, program code segments, drivers, firmware, micro-codes, circuits, data, database, data structures, tables, arrays, and variables. Furthermore, functions provided in the components and the “modules” or “units” may be combined into a smaller number of components and “modules” or “units”, or further divided into additional components and “modules” or “units.”

The “module” or “unit” may be implemented as a processor and a memory, or may be implemented as a circuit (circuitry). Terms like “circuit” and “circuitry” may refer to circuits in hardware, but may also refer to circuits in software. The “processor” should be interpreted broadly to encompass a general-purpose processor, a central processing unit (CPU), a microprocessor, a digital signal processor (DSP), a controller, a microcontroller, a state machine, and so forth. Under some circumstances, the “processor” may refer to an application-specific integrated circuit (ASIC), a programmable logic device (PLD), a field-programmable gate array (FPGA), and so on. The “processor” may refer to a combination for processing devices, e.g., a combination of a DSP and a microprocessor, a combination of a plurality of microprocessors, a combination of one or more microprocessors in conjunction with a DSP core, or any other combination of such configurations. In addition, the “memory” should be interpreted broadly to encompass any electronic component that is capable of storing electronic information. The “memory” may refer to various types of processor-readable media such as random access memory (RAM), read-only memory (ROM), non-volatile random access memory (NVRAM), programmable read-only memory (PROM), erasable programmable read-only memory (EPROM), electrically erasable PROM (EEPROM), flash memory, magnetic or marking data storage, registers, and so on. The memory is said to be in electronic communication with a processor if the processor can read information from and/or write information to the memory. The memory integrated with the processor is in electronic communication with the processor.

In the present disclosure, a “system” may refer to at least one of a server device and a cloud device, but is not limited thereto. For example, the system may include one or more server devices. In another example, the system may include one or more cloud devices. In still another example, the system may include both the server device and the cloud device operated in conjunction with each other.

In addition, terms such as first, second, A, B, (a), (b), etc. used in the following examples are only used to distinguish certain components from other components, and the nature, sequence, order, etc. of the components are not limited by the terms.

In addition, in the following examples, if a certain component is stated as being “connected,” “combined” or “coupled” to another component, it is to be understood that there may be yet another intervening component “connected,” “combined” or “coupled” between the two components, although the two components may also be directly connected or coupled to each other.

In addition, as used in the following examples, “comprise” and/or “comprising” does not foreclose the presence or addition of one or more other elements, steps, operations, and/or devices in addition to the recited elements, steps, operations, or devices.

In the present disclosure, “each of a plurality of A” may refer to each of all components included in the plurality of A, or may refer to each of some of the components included in a plurality of A.

Before describing various examples of the present disclosure, terms used will be described.

In the examples of the present disclosure, “artificial intelligence calculation” may refer to any calculation associated with a machine learning model (e.g., an artificial neural network model, etc.). For example, the artificial intelligence calculation may be a calculation performed in each layer included in the artificial neural network model. For example, the artificial intelligence calculation may include an addition calculation, a subtraction calculation, a maximum value computation calculation, a minimum value computation calculation, a floating point multiplication calculation, weighting calculation, a convolution calculation, a matrix multiplication calculation, a batch normalization calculation, a Rectified Linear Unit (ReLU) calculation, a pooling calculation, a Long Short-Term Memory (LSTM) calculation, a Gated Recurrent Unit (GRU) calculation, etc., performed in a layer included in the artificial neural network model, but is not limited thereto.

The “artificial intelligence program” may herein be a source program that performs calculations associated with artificial intelligence or artificial neural network models. For example, the artificial intelligence program may be a source program associated with deep learning calculation.

The “code” may herein refer to any code prepared to execute a program, and may refer to a source code, for example. In addition, codes may be associated with instructions for calculations.

In performing the artificial intelligence calculations, a “primitive operation” may herein refer to an operation of a processor associated with basic codes and/or basic instructions. For example, the primitive operation may be included in a set of calculation operations frequently used to infer a result value in a machine learning model. For example, the primitive operation may include operations related to calculations such as addition, subtraction, maximum value calculation, minimum value calculation, floating point multiplication, convolution calculation, matrix multiplication, batch normalization, ReLU, pooling, LSTM, GRU, etc., but are not limited thereto.

A “trace” may herein include at least one code and/or at least one primitive operation associated with the artificial intelligence calculation. For example, the trace may be created by collecting calculation-related codes and/or primitive operations extracted during runtime in which an artificial intelligence program is executed. The trace may include a correlation with an execution order of each code and/or primitive operation.

An “accelerator” may herein refer to any processor or circuitry that performs artificial intelligence calculations. For example, the accelerator may refer to a processor or circuitry capable of performing artificial intelligence calculations quickly, and may include a graphics processing unit (GPU), a neural processing unit (NPU), a tensor processing unit (TPU), etc., for example, but is not limited thereto.

An operation library may herein be a collection or library of codes associated with a call of primitive operations. For example, the operation library may include a first code for calling a first primitive operation associated with an addition, a second code for calling a second primitive operation associated with a subtraction, a third code for calling a third primitive operation associated with a maximum value calculation, and a fourth code for calling a fourth primitive operation associated with a minimum value calculation. Additionally, the operation library may include a fifth code for calling a fifth primitive operation associated with a floating point multiplication, a sixth code for calling a sixth primitive operation associated with a convolution calculation, a seventh code for calling a seventh primitive operation associated with a matrix multiplication calculation, and an eighth code for calling an eighth primitive operation associated with a batch normalization. In addition, the operation library may include a code associated with any primitive operation.

Hereinafter, various examples of the present disclosure will be described in detail with reference to the accompanying drawings.

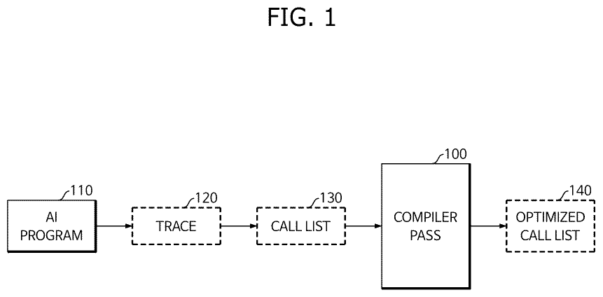

FIG. 1 is a schematic diagram illustrating a method for creating a call list 130. Referring to FIG. 1, an artificial intelligence program 110 may be executed. The artificial intelligence program 110 may be a source program including artificial intelligence calculations. While the artificial intelligence program 110 is running, traces may be acquired. A trace 120 may herein include at least one code and/or at least one primitive operation associated with an artificial intelligence calculation.

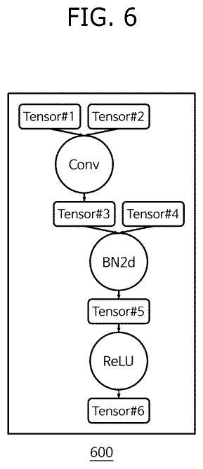

In addition, the call list 130 may be created based on the trace 120. According to some examples, the trace 120 may include a plurality of primitive operations, in which case a plurality of primitive operations may be extracted from the trace 120, and the call list 130 including the extracted plurality of primitive operations may be created. The primitive operations included in the call list 130 may not be in the binary form, but may take at least one form of a data structure, serialized data, or text in memory. The plurality of primitive operations included in the call list 130 may be represented in a graph form, as illustrated in FIG. 6.

The plurality of primitive operations may include any operations included in the operation library. In this case, the operation library may be a library accessible to a plurality of accelerators provided by a plurality of manufacturers.

A correlation for each of the plurality of primitive operations included in the call list 130 may be determined, and the determined correlation for each of the plurality of primitive operations may be included in the call list 130. The correlation may herein refer to a calculation of a specific primitive operation being performed based on another primitive operation. For example, in a relationship in which output data of a first primitive operation is input to a second primitive operation, may be determined that the first primitive operation and the second primitive operation have a correlation. In addition, an execution order of each of the plurality of primitive operations included in the call list 130 may be determined.

A call order and the correlation of the plurality of primitive operations may be represented in a graph form, based on the plurality of primitive operations included in the call list 130. An example of a graph representation of the call list 130 will be described below with reference to FIG. 6.

The call list 130 is transmitted to at least one accelerator, and the at least one accelerator may access the operation library to call and execute a plurality of primitive operations included in the call list 130. According to some examples, the at least one accelerator may compile the plurality of primitive operations included in the call list 130 to create binary codes and then execute the created binary codes to call a plurality of primitive operations.

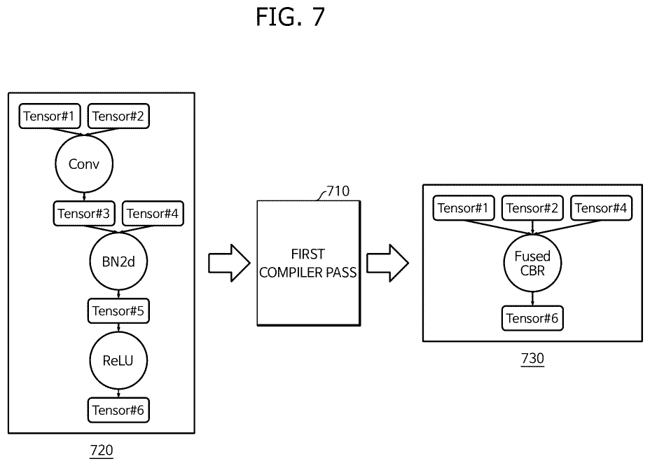

The call list 130 may be applied to a compiler pass 100 such that the call list 130 may be optimized. The compiler pass 100 may herein be a module for optimizing the call list 130. An optimized call list 140 may be created as the original call list 130 is changed. Various methods of optimizing the call list 130 through the compiler pass 100 will be described below with reference to FIGS. 7 to 13.

The compiler pass 100 may be included in an information processing system. In addition, operations related to the compiler pass 100 may be executed by one or more processors included in the information processing system.

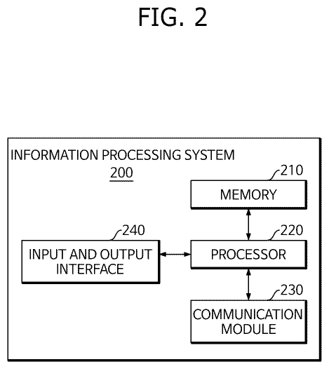

FIG. 2 is a block diagram illustrating an internal configuration of an information processing system 200. The information processing system 200 may include a memory 210, a processor 220, a communication module 230, and an input and output interface 240. The information processing system 200 may be configured to communicate information and/or data through a network using the communication module 230.

The memory 210 may include any non-transitory computer-readable recording medium. The memory 210 may include a permanent mass storage device such as read only memory (ROM), disk drive, solid state drive (SSD), flash memory, and so on. In another example, a non-destructive mass storage device such as ROM, SSD, flash memory, disk drive, and so on may be included in the information processing system 200 as a separate permanent storage device that is distinct from the memory. In addition, the memory 210 may store an operating system and at least one program code (e.g., a code for creating a call list).

These software components may be loaded from a computer-readable recording medium separate from the memory 210. Such a separate computer-readable recording medium may include a recording medium directly connectable to the information processing system 200, and may include a computer-readable recording medium such as a floppy drive, a disk, a tape, a DVD/CD-ROM drive, a memory card, and the like, for example. In another example, the software components may be loaded into the memory 210 through the communication module 230 rather than the computer-readable recording medium. For example, at least one program may be loaded into the memory 210 based on a computer program (e.g., a program for creating an operation call list, etc.) installed by files provided by developers or a file distribution system that distributes application installation files through the communication module 230.

The processor 220 may be configured to process the commands of the computer program by performing basic arithmetic, logic, and input and output calculations. The commands may be provided to a user terminal (not illustrated) or another external system by the memory 210 or the communication module 230. For example, the processor 220 may transmit a call list including a plurality of primitive operations to the accelerator. The accelerator may be included in the information processing system 200 or may be included in another server or system.

The communication module 230 may provide a configuration or function for the user terminal (not illustrated) and the information processing system 200 to communicate with each other through a network, and may provide a configuration or function for the information processing system 200 to communicate with an external system (e.g., a separate cloud system). For example, control signals, commands, data, and the like provided under the control of the processor 220 of the information processing system 200 may be transmitted to the user terminal and/or the external system through the communication module 230 and the network through the communication module of the user terminal, the external system. For example, the processor 220 may transmit a call list to an accelerator included in another server or system through the communication module 230.

In addition, the input and output interface 240 of the information processing system 200 may be a means for interfacing with a device (not illustrated) for inputting or outputting, which may be connected to the information processing system 200 or included in the information processing system 200. In FIG. 2, the input and output interface 240 is illustrated as a component configured separately from the processor 220, but aspects are not limited thereto, and the input and output interface 240 may be configured to be included in the processor 220. The information processing system 200 may include more components than those illustrated in FIG. 2. Meanwhile, most of the related components may not necessarily require exact illustration.

The processor 220 of the information processing system 200 may be configured to manage, process, store the information, data, etc. received from a plurality of user terminals and/or a plurality of external systems. The processor 220 may acquire a trace from the artificial intelligence program and create a call list including a plurality of primitive operations based on the trace.

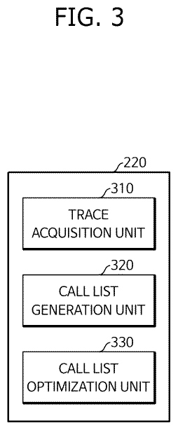

FIG. 3 is a block diagram illustrating an internal configuration of the processor 220. As illustrated in FIG. 3, the processor 220 may include a trace acquisition unit 310, a call list creation unit 320, and a call list optimization unit 330. The call list optimization unit 330 may include the compiler pass 100 of FIG. 1.

The trace acquisition unit 310 may acquire a trace from an artificial intelligence program. The trace acquisition unit 310 may execute an artificial intelligence program, extract a plurality of codes, primitive operations, etc. associated with a calculation, and create a trace including the plurality of extracted codes and/or primitive operations. For example, when the artificial intelligence program is executed, the trace acquisition unit 310 may acquire all codes, all primitive operations, etc. executed through the artificial intelligence program, extract a plurality of codes, primitive operations, etc. associated with calculations from the acquired codes and/or primitive operations, and create a trace including the plurality of extracted codes, primitive operations, etc. The codes, primitive operations, etc. related to the calculation are those associated with the calculation of the accelerator and may be codes, primitive operations, etc. associated with an operation included in the operation library.

The call list creation unit 320 may create a call list including a plurality of primitive operations based on the trace created by the trace acquisition unit 310. The primitive operation included in the call list may not be in the binary form, but may take at least one form of a data structure, serialized data, or text in memory. In addition, the plurality of primitive operations included in the call list may be in the form of a graph. The call list creation unit 320 may represent the call order and correlation of the plurality of primitive operations in a graph form, based on the plurality of primitive operations included in the call list. An example of the graph representation of the call list will be described below with reference to FIG. 6.

The call list optimization unit 330 may optimize the call list created by the call list creation unit 320. The optimized call list may be created based on the original call list. The original call list may herein be a call list created by the call list creation unit 320. The call list optimization unit 330 may optimize the original call list by applying the original call list to at least one compiler pass. The compiler pass may be a module for optimizing the original call list, and the call list optimization unit 330 may include at least one compiler pass.

The original call list may be optimized based on a calculation type of the primitive operation, an identifier (e.g., name) of the primitive operation, the number of accelerators to which the call list is transmitted, etc. Referring to FIGS. 7 to 13, a method for optimizing the original call list through various compiler passes will be described.

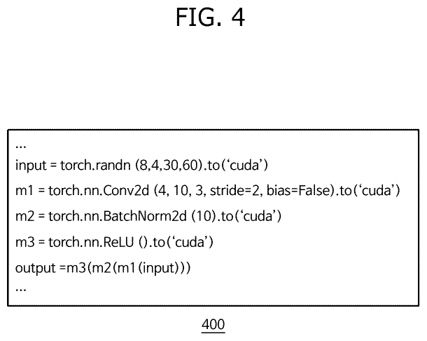

FIG. 4 illustrates an example of a trace 400 acquired from an artificial intelligence program. As illustrated in FIG. 4, a plurality of codes related to calculations may be included in the trace 400. In addition, the trace 400 may include a plurality of primitive operations. FIG. 4 illustrates that a plurality of primitive operations related to convolution (Conv2d) calculation, batch normalization calculation (BatchNorm2d), and ReLU calculation are included in the trace 400, and that input data and output data are additionally included in the trace 400.

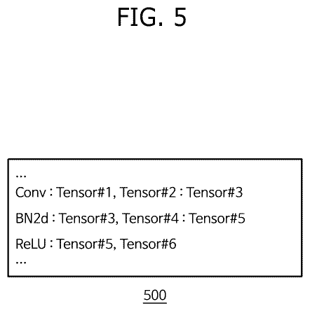

FIG. 5 illustrates a call list 500. Referring to FIG. 5, the call list 500 including at least one primitive operation may be created. The call list 500 may be created based on the trace. For example, by analyzing a plurality of codes included in the trace, a plurality of primitive operations may be extracted from the trace, and a call list including the plurality of extracted primitive operations may be created. As another example, if the trace includes a plurality of primitive operations, the plurality of primitive operations may be extracted from the trace, and a call list including the plurality of extracted primitive operations may be created.

The order of primitive operations may be determined based on the execution order of the codes, primitive operations, etc. included in the trace, and input data and output data of primitive operations may be determined based on input data associated with the code and output data associated with the code. FIG. 5 illustrates that the call list 500 includes a primitive operation (Conv2d) associated with a convolution calculation, a primitive operation (BatchNorm2d) associated with a batch normalization calculation, and a primitive operation (ReLU) associated with a ReLU operation. In addition, it is illustrated that the input data and the output data are determined for each operation. For example, input data of the primitive operation Conv associated with the convolution calculation may be a first tensor (Tensor #1) and a second tensor (Tensor #2), and output data may be a third tensor (Tensor #3).

In addition, operations having a correlation among a plurality of primitive operations included in the call list 500 may be determined. If the output data of the first primitive operation is input as the input data of the second primitive operation, it may be determined that there is a correlation between the first primitive operation and the second primitive operation. Taking FIG. 5 as an example, it may be determined that the primitive operation (Conv2d) associated with the convolution calculation and the primitive operation (BatchNorm2d) associated with the batch normalization are correlated with each other. As another example, it may be determined that the primitive operation associated with the batch normalization (BatchNorm2d) and the primitive operation associated with the ReLU calculation are correlated with each other. Information on the correlation of primitive operations may be recorded in the call list.

FIG. 6 illustrates an example of a call list represented in the form of a graph 600. The graph 600 illustrated in FIG. 6 may be a graph representation based on the call list 500 of FIG. 5. As illustrated in FIG. 6, it may be represented in the form of a data flow graph in which primitive operations are sequentially executed from top to bottom. As illustrated in FIG. 6, input data and output data are represented by rectangles, and primitive operations are represented by circles. In addition, the direction of the arrow may relate to data input to the primitive operation or data output from the primitive operation.

A call list may be transmitted to at least one accelerator. Upon receiving the call list, the accelerator may access the operation library to call and execute a plurality of primitive operations included in the call list.

Meanwhile, the original call list may be applied to at least one compiler pass, so that a plurality of primitive operations included in the original call list may be optimized. The original call list may be a call list created based on the trace, and may be a call list before applying a compiler pass.

Hereinafter, with reference to FIGS. 7 to 13, various methods for optimizing the original call list through various compiler passes will be described. For convenience of explanation, optimizing a call list in a graph representation will be described as an example.

FIG. 7 illustrates that a first call list 720 is passed through a first compiler pass 710 and optimized into a second call list 730. The first call list 720 may be an original call list, and the second call list 730 may be an optimized call list created based on the first call list 720.

It may be determined whether or not the first call list 720 is applicable to the first compiler pass 710 based on a plurality of primitive operation identifiers (e.g., names, indexes, etc.) included in the first call list 720. For example, the first compiler pass 710 may determine whether or not there are a plurality of primitive operations to be merged, based on the plurality of primitive operation identifiers and the execution order included in the first call list 720. The first compiler pass 710 may be a module provided to merge a plurality of primitive operations into one primitive operation.

Merge reference data including identifiers (e.g., names) of a plurality of mergeable primitive operations and operation identifiers used during merging may be stored in the information processing system, and the first compiler pass 710 may determine a plurality of primitive operations to be merged from among all primitive operations included in the first call list 720 based on the stored merge reference data. The first compiler pass 710 may determine, as the primitive operations to be merged, a plurality of continuously executed primitive operations, and merge the determined primitive operations to be merged into one primitive operation.

FIG. 7 illustrates that the first primitive operation (Conv), the second primitive operation (BN2d), and the third primitive operation (ReLU) included in the first call list 720 are determined to be the primitive operations to be merged, and the first to third primitive operations are merged into the fourth primitive operation (FusedCBR). The fourth primitive operation (FusedCBR) may be an operation that integrally performs the first to third primitive operations.

Input data to the fourth primitive operation (FusedCBR) may be determined from among a plurality of pieces of input data to each of the first to third primitive operations to be merged. If a plurality of primitive operations are merged into one operation, an identifier of at least one piece of input data to the merged primitive operation may be recorded in merge reference data. The identifier of the input data may refer to any one of a plurality of pieces of input data to each of a plurality of primitive operations to be merged. Input data to the fourth primitive operation (FusedCBR) may be determined from among a plurality of pieces of input data to each of the first to third primitive operations to be merged based on merging reference data.

FIG. 7 illustrates that the input data to the fourth primitive operation (FusedCBR) included in the optimized second call list 730 is a first tensor (Tensor #1), a second tensor (Tensor #2), and a fourth tensor (Tensor #4). The first tensor (Tensor #1) and the second tensor (Tensor #2) in the first call list 720 may be the input data to the first primitive operation (Conv), and the fourth tensor (Tensor #4) may be the input data to the second primitive operation (BN2d). The selecting the primitive operations to be merged, the merging the operations, etc. described above may be performed by the first compiler pass 710.

The second call list 730 that passed through the first compiler pass 710 may have fewer operations than the first call list 720. If the calculation is performed based on the second call list 730, fewer computing resources may be used and the calculation speed may be faster than performing calculation based on the first call list 720.

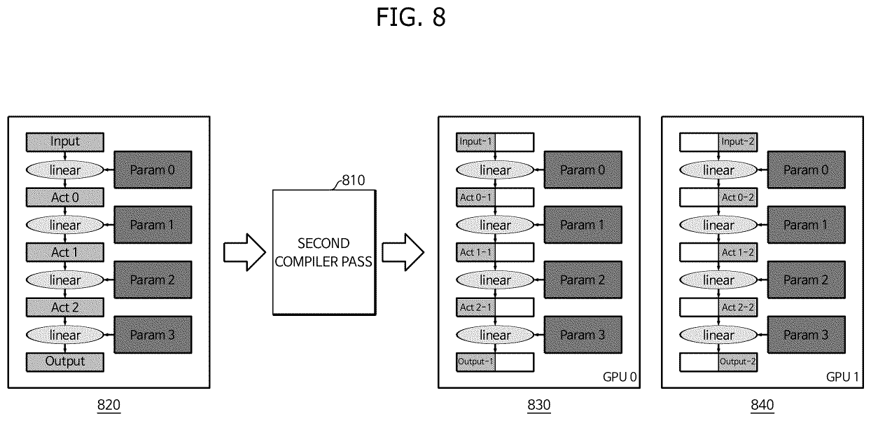

FIG. 8 illustrates that a first call list 820 is passed through a second compiler pass 810 and is changed to a first sub call list 830 and a second sub call list 840. The first call list 820 may be an original call list, and the first sub call list 830 and the second sub call list 840 may be optimized call lists created based on the first call list 820. The second compiler pass 810 may be a module for parallel processing the input data. The second compiler pass 810 may create the first sub call list 830 and the second sub call list 840 based on the first call list 820 for parallel processing by a plurality of accelerators. If there are a plurality of accelerators to which the call list is transmitted, the first call list 820 may be applied to the second compiler pass 810. Additionally, if the input data included in the first call list 820 can be calculated in a divided manner, the first call list 820 may be applied to the second compiler pass 810.

FIG. 8 illustrates that the first call list 820 includes a plurality of linear transform primitive operations. In FIG. 8, “Act” may represent activation, and “Param” may represent parameter data applied to a layer of a machine learning model. The activation is a result of calculation associated with a layer of a machine learning model and may be used as input data of a primitive operation, and the parameter data may be associated with a weight applied to the layer. The parameter data may converge to an optimal value as the machine learning model is repeatedly trained. In addition, ellipses associated with “linear” in FIG. 8 may be primitive operations that performs calculations based on the input data and/or the activation and the parameter data.

Each of the input data and the activation may be divided into a plurality of data and activations. If each of the input data and the activation can be divided into a plurality of data and activations, a plurality of sub call lists 830 and 840 may be be created to include the divided input data and activations. For example, the input data (Input) may be divided into first sub-input data (Input-1) and second sub-input data (Input-2), and in this case, first sub input data (Input-1) may be included in the first sub call list 830, and second sub input data (Input-2) may be included in the second sub call list 840.

Through the second compiler pass 810, the input data (input) may be divided into a plurality of pieces of data based on a size of the mini-batch and processed. For example, the input data (input) may be divided into a plurality of pieces of sub-input data based on the number of accelerators and the size of the mini-batch for parallel processing the first call list 820. For example, if the size of the mini-batch of the input data (input) is “16” and the number of accelerators is “2”, the input data (input) may be divided into first sub-input data (Input-1) and second sub-input data (Input-2) each including 8 mini-batches. If the input data (Input) is divided into sub-input data (Input-1, Input-2) in units of mini-batches, the activations (Act 0 to Act 2) may also be divided into sub-activations (Act 0-1 to Act 2) in units of mini-batches, and additionally, the output data (Output) may also be divided into sub-output data (Output-1, Output-2) in units of batches. If the input data (Input) is divided into sub-input data (Input-1, Input-2), partial calculations based on the sub-input data (Input-1, Input-2) are performed through a machine learning model (e.g., an artificial neural network model, etc.), and the activation (Act) output through the machine learning model may also be divided and output. As illustrated in FIG. 8, the first activation (Act 0) may be divided into a first sub-activation (Act 0-1) and a second sub-activation (Act 0-2), and in this case, the first sub-activation Act 0-1 may be included in the first sub call list 830, and the second sub-activation Act 0-2 may be included in the second sub call list 840. The first sub activation (Act 0-1) may be calculated based on the first sub input data (Input-1), and the second sub activation (Act 0-2) may be calculated based on the second sub input data (Act 0-2).

The number of divisions of the input data and the activation may correspond to the number of accelerators transmitting call lists. For example, if there are (n) number of accelerators to which the call list is transmitted (where, n is a natural number equal to or greater than 2), the number of divisions of the input data and the activation may also be (n). The size and number of divided data may be equivalent or differential. For example, if the input data is divided into first sub-input data and second sub-input data, the size of the first sub-input data and the size of the second sub-input data may be the same as each other, or the size of the first sub-input data may be greater or less than the size of the second sub input data. The number of accelerators to which the call list is transmitted may be determined based on user input, or may be determined based on the number by which each of the input data, activations, etc. can be divided.

FIG. 8 illustrates that there are two accelerators to which a call list is transmitted, and accordingly, the input data (Input) and the activation (Act) are divided into two pieces of data and activations. FIG. 8 illustrates that the input data (Input) is divided into the first sub-input data (Input-1) and the second sub-input data (Input-2). Additionally, FIG. 8 illustrates that the first activation (Act 0) is divided into a plurality of sub-activations (Act 0-1 and Act 0-2), and each of the second and third activations (Act 1 and Act 2) is also divided into a plurality of sub-activations (Act 1-1, Act 1-2, Act 2-1 and Act 2-2). Additionally, it is illustrated that the output data (Output) is also divided into first sub-output data (Output-1) and second sub-output data (Output-2).

The first sub call list 830 acquired from the second compiler pass 810 may include some of the divided input data and activations, and the second sub call list 840 may include the rest of the divided input data and activations. As illustrated in FIG. 8, the first sub call list 830 includes first sub input data (Input-1) and a plurality of sub activations (Act 0-1, Act 1-1, and Act 2-1), and the second sub call list 840 may include second sub input data (Input-2) and a plurality of sub activations (Acts 0-2, Act 1-2, and Act 2-2). The first sub-output data (Output-1) may be result data calculated based on the first sub call list 830, and the second sub-output data (Output-2) may be result data calculated based on the second sub call list 840. That is, a plurality of primitive operations associated with each of the first sub input data (Input-1) and the plurality of sub activations (Act 0-1, Act 1-1, and Act 2-1) included in the first sub call list 830 are executed, and the first sub output data (Output-1) may be output. In addition, a plurality of primitive operations associated with each of the first sub input data (Input-2) and the plurality of sub activations (Act 0-2, Act 1-2, and Act 2-2) included in the second sub call list 840 are executed, and the second sub output data (Output-2) may be output.

Among the call lists 830 and 840 acquired from the second compiler pass 810, the first sub call list 830 may be transmitted to the first accelerator (GPU 0), and the second sub call list 840 may be transmitted to the second accelerator (GPU 1), so that primitive operations included in the first sub call list 830 and primitive operations included in the second sub call list 840 may be executed in parallel through the first accelerator (GPU 0) and the second accelerator (GPU 1). The dividing the input data, the activation, etc. described above may be performed by the second compiler pass 810.

The results of execution through the first accelerator (GPU 0) and the second accelerator (GPU 1) may be aggregated by one or more accelerators and/or one or more processors. For example, the second accelerator (GPU 1) may execute all primitive operations included in the second sub call list 840 and then transmits the acquired second sub output data (Output-2) to the first accelerator (GPU 0). In addition, the first accelerator (GPU 0) may create final result data based on the first sub output data (Output-1) acquired by executing all primitive operations included in the first sub call list 830 and the second sub output data (Output-2) received from the second accelerator (GPU 1). The final result data may be a value associated with a gradient. For example, if the first sub-output data (Output-1) received from the first accelerator (GPU 0) is associated with a first gradient and the second sub-output data (Output-2) received from the second accelerator (GPU 1) is associated with a second gradient, the first and second gradients may be reflected and the final result data may be acquired.

In some examples, the results (Output-1 and Output-2) of execution through the first accelerator (GPU 0) and the second accelerator (GPU 1) may be subsequently processed without being aggregated in a specific accelerator. For example, the sub-output data (Output-1 and Output-2) created through each of the first accelerator (GPU 0) and the second accelerator (GPU 1) may be stored in a memory of a specific accelerator. In this case, the specific accelerator may create final result data based on the sub output data (Output-1, Output-2) stored in its memory. As another example, the sub-output data (Output-1 and Output-2) created through each of the first accelerator (GPU 0) and the second accelerator (GPU 1) may be stored in the main memory of the information processing system. In this case, the processor included in the information processing system may create final result data based on the sub output data (Output-1 and Output-2) stored in the main memory. As still another example, the first sub-output data (Output-1) created through the first accelerator (GPU 0) may be managed by the first accelerator (GPU 0) without being transmitted to another accelerator or memory, and similarly, the second sub-output data (Output-2) created through the second accelerator (GPU 1) may also be managed by the second accelerator (GPU 1) without being transmitted to another accelerator or memory. In this case, the first sub-output data (Output-1) and the second sub-output data (Output-2) may be continuously maintained in the divided state.

Meanwhile, a target accelerator to transmit the plurality of sub call lists 830 and 840 to may be determined based on the location of the accelerator. In order to minimize communication delay during gathering of the output data, the target accelerator to transmit the plurality of call lists 830 and 840 to may be determined such that the first accelerator (GPU 0) and the second accelerator (GPU 1) receiving the sub call lists 830 and 840 are included in the same node. The node may herein refer to a physically or logically separated computing device (e.g., a server, a user terminal, etc.) If a plurality of accelerators included in the same node are not retrieved, the target accelerators to transmit the plurality of sub call lists 830 and 840 to may be determined such that the first node including the first accelerator (GPU 0) and the second node including the second accelerator (GPU 1) are located adjacent to each other. In this case, the first node may be a neighbor node to the second node.

As described above, when the first call list 820 is passed through the second compiler pass 810, the plurality of sub call lists 830 and 840 for parallel processing of data may be acquired. Each of the plurality of sub call lists 830 and 840 is transmitted to a plurality of accelerators (GPU 0 and GPU 1), and each primitive operation included in the plurality of sub call lists 830 and 840 may be executed in parallel. If a plurality of accelerators are used for the parallel processing of data, the calculation speed may be further improved.

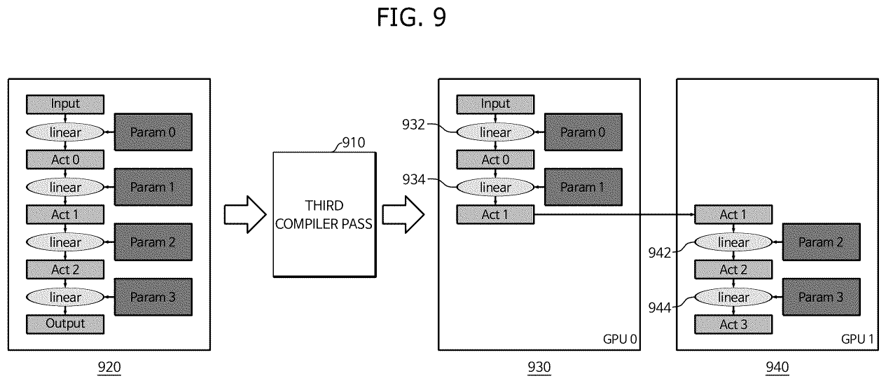

FIG. 9 illustrates that a first call list 920 is passed through a third compiler pass 910 and is changed to a first sub call list 930 and a second sub call list 940. The first call list 920 may be an original call list, and the first sub call list 930 and the second sub call list 940 may be optimized call lists in which primitive operations included in the first call list 920 are divided. When passed through the third compiler pass 910, the first call list 920 may be divided into the first sub call list 930 and the second sub call list 940. The third compiler pass 910 may be a module for dividing the call list and performing pipeline-based parallelism of the primitive operations included in the divided call list.

If there are a plurality of accelerators to which the call list is transmitted, the first call list 920 may be applied to the third compiler pass 910. The number of accelerators to which the sub call lists 930 and 940 are transmitted may be determined based on user input, or may be determined based on the number by which each of the input data, output data, activations, etc. can be divided.

As illustrated in FIG. 9, the first call list 920 may be divided into a plurality of sub call lists 930 and 940 based on the number of accelerators. For example, the plurality of primitive operations included in the first call list 920 may be divided into a first subgroup and a second subgroup, and the first sub call list 930 including the primitive operations included in the first subgroup and the second sub call list 940 including the primitive operations included in the second subgroup may be created. The first sub call list 930 and the second sub call list 940 may be transmitted to different accelerators, respectively. FIG. 9 illustrates that the first sub call list 930 is transmitted to the first accelerator (GPU 0), and the second sub call list 940 is transmitted to the second accelerator (GPU 1).

Pipelining may be performed between the divided first sub-list 930 and second sub call list 940. For pipelining, a command may be inserted into at least one of the first sub call list 930 and the second sub call list 940 such that result data output through the primitive operations included in the first sub call list 930 are provided as input data of the primitive operations included in the second sub call list 940. For example, a command associated with providing the result data may be inserted into the first sub call list 930 such that the data output through the last executed primitive operation of the primitive operations included in the first sub call list 930 is provided as the input data of the first executed primitive operation of the primitive operations included in the second sub call list 940. The command associated with providing the result data may be a command for transmitting data output through the last executed primitive operation of the primitive operations included in the first sub call list 930 to the second accelerator (GPU 1). In this case, if the output data based on the first sub call list 930 is received, the second accelerator (GPU 1) may sequentially execute the primitive operations included in the second sub call list 940.

FIG. 9 illustrates that ellipses associated with “linear” are the primitive operations that perform calculations based on the input data and/or the activation and parameter data. As illustrated in FIG. 9, a first primitive operation 932 and a second primitive operation 934 may be included in the first sub call list 930, and a third primitive operation 942 and a fourth primitive operation 944) may be included in the second sub call list 940.

A first command for transmitting result data (Act 1) output from the second primitive operation 934 to the second accelerator (GPU 1) may be inserted into the second call list 930. Additionally or alternatively, a second command for receiving result data (Act 1) of the second primitive operation 934 from the first accelerator (GPU 0) may be inserted into the third call list 940. The inserting the command and the dividing the call list described above may be performed through the third compiler pass 910.

Meanwhile, a target accelerator to transmit the plurality of sub call lists 930 and 940 to may be determined based on the location of the accelerator. In order to minimize communication delay between the accelerators, a target accelerator to transmit the plurality of sub call lists 930 and 940 to may be determined such that the first accelerator (GPU 0) and the second accelerator

(GPU 1) that communicate with each other through the inserted command are included in the same node. The node may herein refer to a physically or logically separated computing device (e.g., a server, a user terminal, etc.)

If a plurality of accelerators included in the same node are not retrieved, the target accelerators to transmit the plurality of sub call lists 930 and 940 to may be determined such that the first node including the first accelerator (GPU 0) and the second node including the second accelerator (GPU 1) are located adjacent to each other. In this case, the first node may be a neighbor node to the second node.

As described above, if the divided sub call lists 930 and 940 are processed through a plurality of accelerators, the entire computing resources of the information processing system can be managed more efficiently. For example, based on the pipeline, the plurality of sub call lists 930 and 940 may be processed in parallel through a plurality of accelerators, thereby increasing the throughput of the accelerator per unit time and shortening the total calculation time. In addition, since the whole calculation is divided into small calculations and processed in parallel through a plurality of accelerators, memory resources used by each of the plurality of accelerators may be reduced. In addition, the divided sub call lists 930 and 940 are allocated to the accelerators with low load and processed, so that the number of accelerators in an idle state can be minimized.

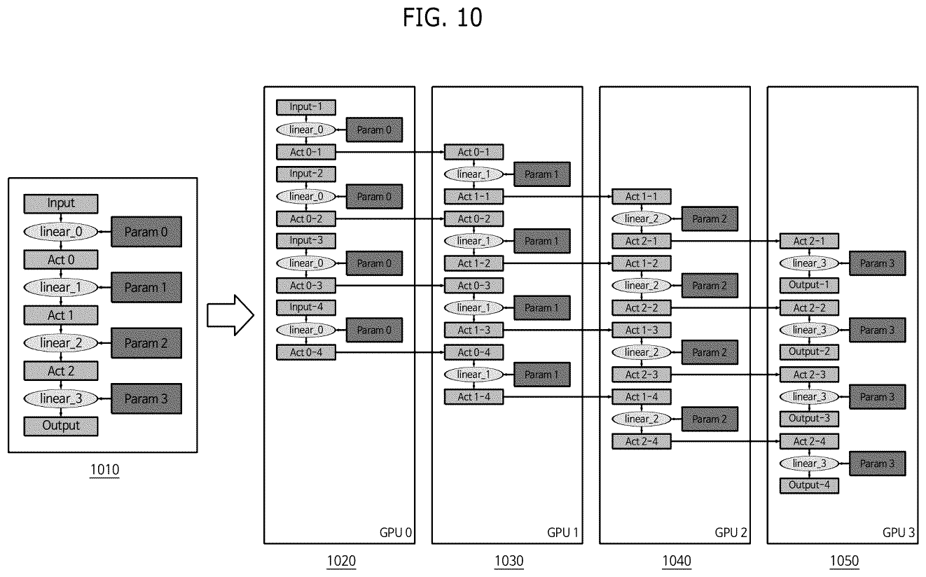

FIG. 10 illustrates that a first call list 1010 is passed through the third compiler pass and is changed to a first sub call list 1020 to a fourth sub call list 1050. The third compiler may create first to fourth sub call lists 1020 to 1050 based on the first call list 1010. The third compiler may create a plurality of sub call lists 1020 to 1050 based on the original call list 1010 and the number of accelerators for parallel processing the first call list 1010. The sub call lists 1020 to 1050 illustrated in FIG. 10 may be associated with pipeline parallelism for four accelerators (GPU 0 to GPU 3).

FIG. 10 illustrates that the original call list 1010 includes a plurality of linear transform primitive operations. In FIG. 10, “Act” may represent activation, and “Param” may represent parameter data applied to a layer of a machine learning model. In addition, ellipses associated with “linear” in FIG. 10 may be primitive operations that performs calculations based on the input data and/or the activation and the parameter data.

The input data (input) may be divided into a plurality of pieces of sub-input data in units of batches and processed. FIG. 10 illustrates that the input data (input) is divided into sub-input data (input-1 to input-4) of four batch units. If input data (Input) is divided into sub-input data (Input-1 to Input-4), activations (Act 0 to Act 2) may also be divided into a plurality of sub-activations (Act 0-1 to Act 2-4) in units of batches, and additionally, output data (Output) may also be divided into a plurality of sub-output data (Output-1 to Output-4) in units of batches. As illustrated in FIG. 10, at least one of a plurality of primitive operations (linear_0 to linear_3) may be included in the sub call lists 1020 to 1050. FIG. 10 illustrates that the first sub call list 1020 includes a first primitive operation (linear_0), the second sub call list 1030 includes a second primitive operation (linear_1), the third sub call list 1040 includes a third primitive operation (linear_2), and the fourth sub call list 1050 includes a fourth primitive operation (linear_3).

Two or more of th sub call lists 1020 to 1050 may be pipelined. FIG. 10 illustrates that the first sub call list 1020 and the second sub call list 1030 are pipelined, the second sub call list 1030 and the third sub call list 1040 are pipelined, and the third sub call list 1040 and the fourth sub call list 1050 are pipelined.

For pipelining, a command may be inserted into at least one of the first sub call list 1020 and the second sub call list 1030 such that result data output through the primitive operations included in the first sub call list 1020 are provided as input data of the primitive operations included in the second sub call list 1030. For example, a command associated with providing the result data may be inserted into the first sub call list 1020 such that each of the data (Acts 0-1 to Act 0-4) output through the first primitive operation (linear_0) included in the first sub call list 1020 is provided as input data of the primitive operation (linear_1) included in the second sub call list 1030. The command associated with providing the result data may be a command for transmitting data output through the first primitive operation (linear_0) included in the first sub call list 1020 to the second accelerator (GPU 1).

Likewise, a command associated with providing the result data may be inserted into the second sub call list 1030 such that each of the data (Acts 1-1 to Act 1-4) output through the second primitive operation (linear_1) included in the second sub call list 1030 is provided as input data of the primitive operation (linear_2) included in the third sub call list 1040. In addition, a command associated with providing the result data may be inserted into the third sub call list 1040 such that each of the data (Acts 2-1 to Act 2-4) output through the third primitive operation (linear_2) included in the third sub call list 1040 is provided as input data of the fourth primitive operation (linear_3) included in the fourth sub call list 1050.

As illustrated in FIG. 10, the sub call lists 1020 to 1050 may be transmitted to a plurality of accelerators (GPU 0 to GPU 3), and the plurality of sub call lists 1020 to 1050 may be processed in parallel through the plurality of accelerators (GPU 0 to GPU 3).

Meanwhile, FIG. 10 illustrates that one accelerator (GPU 0 to GPU 3) executes one primitive operation, but aspects are not limited thereto, and one accelerator may execute a plurality of primitive operations and transmit results output through each of the plurality of operations to another accelerator. The number of primitive operations to be allocated to a specific accelerator of a plurality of primitive operations may be determined based on at least one of performance or state of the accelerator. For example, if an accelerator has a large throughput, a large memory capacity, or a low utilization rate, a sub call list including a larger number of primitive operations may be transmitted to the accelerator.

As described above, if the sub call lists 1020 to 1050 are processed through a plurality of accelerators, the entire computing resources of the information processing system can be managed more efficiently. For example, based on the pipeline, the plurality of sub call lists 1020 to 1050 may be processed in parallel through a plurality of accelerators, thereby increasing the throughput of the accelerator per unit time and shortening the total calculation time. In addition, since the whole calculation is divided into small calculations and processed in parallel through a plurality of accelerators, memory resources used by each of the plurality of accelerators may be reduced. In addition, the divided sub call lists 1020 to 1050 are allocated to the accelerators with low load and processed, so that the number of accelerators in an idle state can be minimized.

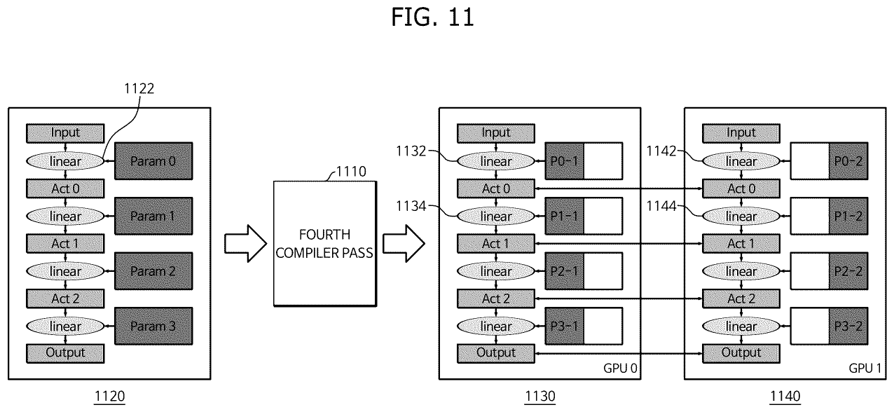

FIG. 11 illustrates that a first call list 1120 is passed through a fourth compiler pass 1110 and is changed to a first sub call list 1130 and a second sub call list 1140. The first call list 1120 may be an original call list, and the first sub call list 1130 and the second sub call list 1140 may be call lists created based on the first call list 1120. When the first call list 1120 is passed through the fourth compiler pass 1110, the first sub call list 1130 and the second sub call list 1140 may be acquired. The fourth compiler pass 1110 may be a module for parallel processing the parameter data. If there are a plurality of accelerators to which the call list is transmitted, the first call list 1120 may be applied to the fourth compiler pass 1110.

FIG. 11 illustrates that the first call list 1120 includes a plurality of linear transform primitive operations. FIG. 11 illustrates that “Param” is parameter data applied to a layer of a machine learning model. The activation (Act) illustrated in FIG. 11 may be a calculation result associated with a layer of a machine learning model, and the parameter data may be associated with a weight applied to the layer. In addition, ellipses having a text “linear” therein may be primitive operations that perform calculations based on the input data and/or the activation and the parameter data.

Each parameter data may include a plurality of parameters. The plurality of parameters may be a plurality of weights applied to nodes included in a specific layer. Each of the plurality of weights may be, in a calculation, weights that are applied to variables (e.g., input values) and/or constants.

The number by which the parameter data is divided may be determined based on the number of accelerators to which the call list is transmitted, and the parameter data may be divided by the determined number based on the determined number. Each of a plurality of parameters applied to each of a plurality of primitive operations may be divided by the determined number. The divided parameter data may include equivalent or differential numbers of parameters.

The plurality of sub call lists 1130 and 1140 including each of the divided parameter data may be created. FIG. 11 illustrates that each of a plurality of parameter data is divided into two. That is, it is illustrated that the first parameter data (Param 0) is divided into two pieces of sub-parameter data (P0-1, P0-2), and the other parameter data (Param 1 to Param 3) is also divided into two pieces of sub-parameter data (P1-1, P1-2, P2-1, P2-2, P3-1, P3-2). In addition, it is illustrated that the sub-parameter data (P0-1, P1-1, P2-1, and P3-1) corresponding to the first group of divided sub-parameter data are included in the first sub call list 1130, and a plurality of sub-parameter data (P0-1, P1-1, P2-1, and P3-1) corresponding to the second group are included in the second sub call list 1140.

If an operation is performed using the divided parameter data, only a part of the primitive operations may be performed in a specific accelerator. For example, if the first accelerator (GPU 0) executes a first primitive operation 1132 included in the first sub call list 1130, the first accelerator (GPU 0) may only perform a calculation based on the first sub-parameter data (P0-1), but may not be able to perform a calculation based on the second sub-parameter data (P0-2). Similarly, if the second accelerator (GPU 1) executes a first primitive operation 1142 included in the second sub call list 1140, the second accelerator (GPU 1) may only perform a calculation based on the second sub-parameter data (P0-2), but may not be able to perform a calculation based on the first sub-parameter data (P0-1).

Accordingly, the result data of the first primitive operation 1132 executed by the first accelerator (GPU 0) and the result data of the first primitive operation 1142 executed by the second accelerator (GPU 1) should be aggregated to perform an original primitive operation 1122 normally. For example, in the original primitive operation 1122, it can be assumed that the calculation is “Act 0=(a*input)−(b*input)”, where “a” is the first sub-parameter (P0-1), and “b” is the second sub-parameter P0-2”. In this case, the result data of the first primitive operation 1132 executed by the first accelerator (GPU 0) may be calculated based on “(a*input)”, and the result data of the first primitive operation 1142 executed by the second accelerator (GPU 1) may be calculated based on “(b*input)”. In order to calculate a final value for “Act 0” by partially performing the calculation, the partially calculated result data in one accelerator should be transmitted to another accelerator or processor.

A command for sharing a calculation result with each accelerator may be inserted into a call list. For example, a master accelerator may be determined from among a plurality of accelerators to which the call list is transmitted. For example, after determining the state of the accelerator to which the call list is transmitted, the accelerator with the lowest utilization rate may be determined to be the master accelerator, and the rest may be determined to be slave accelerators. In some examples, among a plurality of accelerators included in the information processing system, an accelerator to which the call list is not transmitted may be determined to be a master accelerator.

At least one command for transmitting a calculation result of a primitive operation to the master accelerator may be inserted into the sub call list transmitted to the slave accelerator. If a calculation for a specific primitive operation is completed based on the inserted command, the slave accelerator may immediately transmit the completed calculation result to the master accelerator. The calculation result should be transmitted from the slave accelerator to the master accelerator in real time because it may be necessary to minimize a delay time for the primitive operation that is linearly performed in the master accelerator.

The master accelerator may calculate a final calculation result of the original primitive operation based on the calculation result of the directly executed primitive operation and the calculation result of the primitive operation received from the slave accelerator. In addition, a command for transmitting the final calculation result to the slave accelerator may be inserted into the call list transmitted to the master accelerator.

Referring to FIG. 11 as an example, if the first accelerator (GPU 0) is the master accelerator, at least one command for transmitting the calculation result of each primitive operation to the first accelerator (GPU 0) may be inserted into the second sub call list 1140 transmitted to the second accelerator (GPU 1). In addition, a command for transmitting the final calculation result of the primitive operation to the second accelerator (GPU 1) may be inserted into the second sub call list 1140 transmitted to the second accelerator (GPU 1).

Based on the inserted command, the first accelerator (GPU 0) may receive a calculation result of the first primitive operation 1142 included in the second sub call list 1140 from the second accelerator (GPU 1). In addition, the first accelerator (GPU 0) may calculate the final calculation result (Act 0) of the first primitive operation 1122 based on the partial calculation result of the first primitive operation 1132 included in the first sub call list 1130 and the primitive operation result received from the second accelerator (GPU 1), and transmit the calculated final calculation result to the second accelerator (GPU 1).

Each of the first accelerator (GPU 0) and the second accelerator (GPU 1) may perform partial calculations on second primitive operations 1134 and 1144, and the partial calculation results for the second operations 1134 and 1144 may be aggregated by the first accelerator (GPU 0), which is the master accelerator, so that a final calculation on the second operation can be performed.

The inserting the command and the dividing the parameter data described above may be performed by the fourth compiler pass 1110.

Meanwhile, a target accelerator to transmit the plurality of sub call lists 1130 and 1140 to may be determined based on the location of the accelerator. The first accelerator (GPU 0) and the second accelerator (GPU 1) may be included in the same node or in neighboring nodes such that communication delay between the master accelerator and the slave accelerator can be minimized.

As described above, if the first call list 1120 is passed through the fourth compiler pass 1110, a plurality of sub call lists 1130 and 1140 for parallel processing of parameter may be acquired. Each of the plurality of sub call lists 1130 and 1140 is transmitted to a plurality of accelerators (GPU 0 and GPU 1), and each primitive operation included in the plurality of sub call lists 1130 and 1140 may be executed in parallel. If such parallel processing is performed, calculation speed can be further improved. In addition, since the calculation of the accelerator is performed based on some of the parameter data, memory resources used by the accelerator may be reduced.

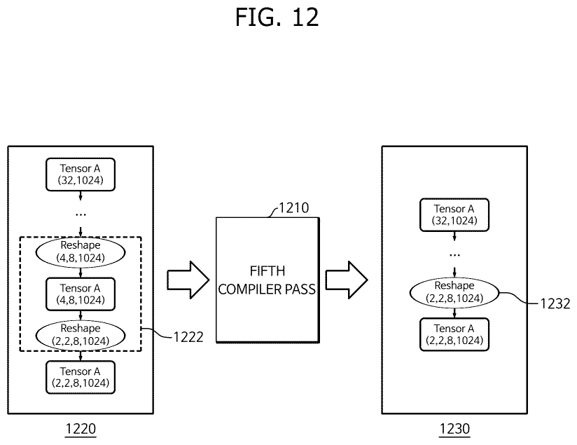

FIG. 12 illustrates that a first call list 1220 is passed through a fifth compiler pass 1210 and is changed into a second call list 1230. The first call list 1220 may be an original call list, and the second call list 1230 may be a call list created based on the first call list 1220. FIG. 12 illustrates a Reshape operation, which is a primitive operation associated with a multidimensional data structure. The Reshape operation is a primitive operation capable of setting the data structure in multiple dimensions and may be related to a memory access area.

It may be determined whether or not the first call list 1220 is applicable to the fifth compiler pass 1210, based on the data structure and operation identifier (e.g., name, index, etc.) associated with each of the plurality of primitive operations included in the first call list 1220. That is, it may be determined whether or not there are a plurality of primitive operations to be merged, based on the data structure and the operation identifier associated with each of the plurality of primitive operations included in the first call list 1220. The fifth compiler pass 1210 may be a module for merging a plurality of primitive operations associated with the data structure into one primitive operation.

If it is determined that there are a plurality of primitive operations to be merged, a plurality of primitive operations to be merged may be determined from among all primitive operations included in the first call list 1220 based on the data structure and the operation identifier associated with the plurality of primitive operations included in the first call list 1220. A plurality of primitive operations for defining or changing the data structure may be determined to be operations to be merged. For example, if a plurality of Reshape operations having a consecutive order are retrieved from the first call list 1220, the plurality of Reshape operations having the consecutive order may be determined to be the primitive operations to be merged.

As illustrated in area 1222 of FIG. 12, among the primitive operations included in the first call list 1220, Reshape(4,8,1024) and Reshape(2,2,8,1024) operations may be determined to be the primitive operations to be merged. In the Reshape operation, the rightmost number may be a matrix size, and other numbers may be multidimensional elements.

The plurality of primitive operations 1222 determined to be the targets to be merged may be merged into one primitive operation 1232. As illustrated in FIG. 12, Reshape(4,8,1024) and Reshape(2,2,8,1024) operations determined to be the targets to be merged may be merged into Reshape(2,2,8,1024). Additionally, the second call list 1230 including the merged operation 1232 may be created and transmitted to at least one accelerator.

The merging the primitive operations described above may be performed through the fifth compiler pass 1210. If the second call list 1230 is created through the fifth compiler pass 1210, final output data may be calculated more quickly compared to the first call list 1220.

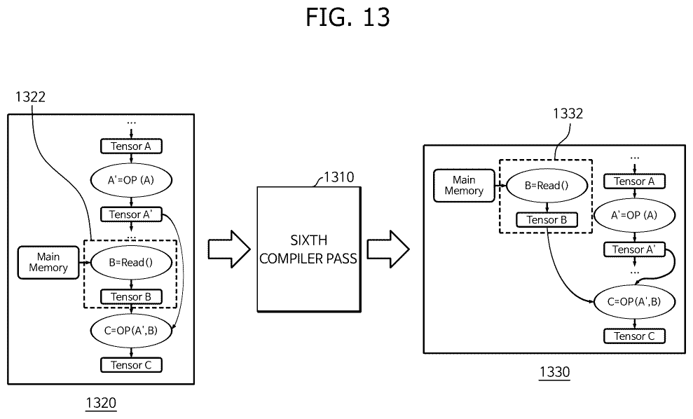

FIG. 13 illustrates that a first call list 1320 is passed through a sixth compiler pass 1310 and is changed into a second call list 1330. The first call list 1320 may be an original call list, and the second call list 1330 may be a call list created based on the first call list 1320.

It may be determined whether or not there is at least one independently performed primitive operation among the plurality of primitive operations included in the first call list 1320. If it is determined that there is at least one independently performed primitive operation, the first call list 1320 may be applied to the sixth compiler pass 1310. The independently performed primitive operation may be an operation that can be independently performed without being affected by the execution result of the primitive operation in the previous order. In addition, the sixth compiler pass 1310 may be a module for outputting calculation results more quickly by adjusting the order of primitive operations.

If it is determined that there is at least one independently executed primitive operation in the first call list 1320, an execution order of the at least one independently executed primitive operation may be changed. In addition, the sixth compiler pass 1310 may create the second call list 1330 such that at least one modified primitive operation is included.

Referring to FIG. 13 as an example, “B=Read( )” may be a primitive operation 1322 that is independently performed and outputs “Tensor B” without being affected by the primitive operations in the previous order. That is, “B=Read( )” may be an independent primitive operation 1322 that can be executed without waiting for the result data of at least one previously executed primitive operation.

The second call list 1330 may be created such that an execution order of an independently executable primitive operation (e.g., B=Raed( ) in FIG. 13) is advanced. For example, the sixth compiler pass 1310 may identify independently executable primitive operations from the first call list 1320 and create the second call list 1330 to advance the identified primitive operations. FIG. 13 illustrates that a primitive operation 1332 related to ‘B=Read( )’ included in the second call list 1330 is advanced in execution order compared with the primitive operation 1322 related to ‘B=Read( )’ included in the first call list 1310. The second call list 1330 may be sent to at least one accelerator.

If the second call list 1330 is created through the sixth compiler pass 1310, final output data can be calculated more quickly compared to the first call list 1320. That is, the time the final output data (e.g., Tensor C in FIG. 13) is output may be shorter in the second call list 1330 than in the first call list 1320.

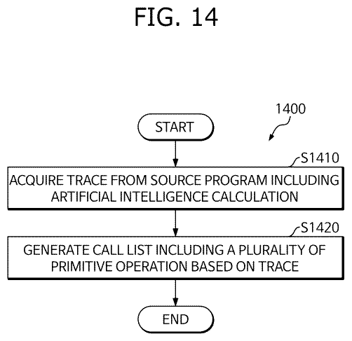

FIG. 14 is a flowchart illustrating a method 1400 for creating an operation call list. The method 1400 illustrated in FIG. 14 is merely one example for achieving the object of the present disclosure, and it goes without saying that certain steps may be added or deleted as needed. In addition, the method 1400 illustrated in FIG. 14 may be performed by one or more processors included in the information processing system. For convenience of description, it will be described that each step illustrated in FIG. 14 is performed by a processor included in the information processing system.

The processor may acquire a trace from a source program including an artificial intelligence calculation, at S1410. The trace may include code and/or primitive operations associated with the source program. The processor may execute the source program to acquire a plurality of codes and/or primitive operations associated with the artificial intelligence calculation, and acquire a trace including the acquired plurality of codes and/or primitive operations.

The processor may create a call list including a plurality of primitive operations based on the trace, at S1420. A plurality of primitive operations may be included in an operation library accessible to each of the plurality of accelerators.

The processor may determine a correlation for each of a plurality of primitive operations, and create a call list including the determined correlation for each of the plurality of primitive operations. The correlation may be a relationship in which output data of the first primitive operation included in the call list is input to the second primitive operation included in the call list.

Additionally or alternatively, the processor may create a graph representing a call order and the correlation of the plurality of primitive operations based on the plurality of primitive operations included in the call list.

The processor may transmit the created call list to at least one of a plurality of accelerators. The accelerator may be configured to, upon receiving the call list, access the operation library and call the plurality of primitive operations included in the call list.

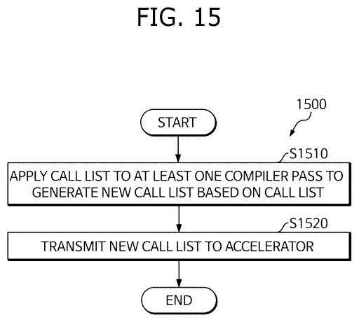

FIG. 15 is a flowchart illustrating a method 1500 for creating a new optimized call list by applying the call list to a compiler pass. The method 1500 illustrated in FIG. 15 is merely one example for achieving the object of the present disclosure, and it goes without saying that certain steps may be added or deleted as needed. In addition, the method 1500 illustrated in FIG. 15 may be performed by one or more processors included in the information processing system. For convenience of description, it will be described that each step illustrated in FIG. 15 is performed by a processor included in the information processing system.

The processor may apply the call list to at least one compiler pass to create a new call list based on the call list, at S1510. The call list may be the original call list before being applied to the compiler pass. For example, the processor may determine, from among the primitive operations included in the call list, a plurality of primitive operations to be merged, based on the identifier of the primitive operation, and merge the determined plurality of primitive operations into one primitive operation. The processor may modify the call list to include the merged primitive operations to create a new call list. In this case, the input data for each of the determined plurality of primitive operations may be input as a merged primitive operation.

As another example, the processor may determine the number of the plurality of accelerators provided with the call list, and divide at least one of the input data, the activation, or the output data included in the call list based on the determined number of the plurality of accelerators. The processor may change the call list to include at least one of the divided input data, activation data, or output data to create a new call list.

As another example, the processor may determine the number of the plurality of accelerators provided with the call list, and divide the call list into a plurality of sub call lists based on the determined number of the plurality of accelerators. The processor may change the call list such that the divided sub call lists are pipelined to create a new call list. The processor may transmit the plurality of divided sub call lists to the plurality of accelerators. In this case, the first accelerator receiving a first sub call list and the second accelerator receiving a second sub call list pipelined with the first sub call list may be included in the same node. As another example, the first accelerator receiving the first sub call list may be included in the first node, the second accelerator receiving the second sub call list pipelined with the first sub call list may be included in the second node, and the first node may be a neighboring node adjacent to the second node. The processor may insert at least one command into at least one of the first sub call list or the second sub call list such that output data based on the first sub call list is provided as input data of a primitive operation included in the second sub call list.

As still another example, the processor may determine the number of the plurality of accelerators provided with the call list, and divide a plurality of parameters applied to each of the primitive operations included in the call list based on the determined number of the plurality of accelerators. The processor may change the call list to include the divided parameters to create a new call list.

As still another example, the processor may determine, from among the primitive operations included in the call list, a plurality of primitive operations to be merged, based on at least one of a data structure or an identifier associated with the primitive operations, and merge the determined plurality of primitive operations into one primitive operation. The processor may modify the call list to include the merged primitive operations to create a new call list.

As still another example, the processor may identify, among a plurality of primitive operations included in the call list, at least one independently performed primitive operation, and change an execution order of the identified at least one primitive operation. In this case, the processor may change the execution order of the at least one primitive operation such that the execution order of the identified at least one primitive operation is advanced. The processor may change the call list to include the modified at least one primitive operation to create a new call list.

If the creation of the new call list is completed, the processor may transmit the new call list to at least one accelerator, at S1520.

In the embodiments described above, several compiler passes have been described as examples used for optimizing the call list, but various other compiler passes may also be used to optimize the call list. Additionally, the optimized call list may be transmitted to at least one accelerator.

The flowchart and description described above are merely examples, and may be implemented differently in some examples. For example, in some examples, the order of respective steps may be changed, some steps may be repeatedly performed, some steps may be omitted, or some steps may be added.

The method described above may be provided as a computer program stored in a computer-readable recording medium for execution on a computer. The medium may be a type of medium that continuously stores a program executable by a computer, or temporarily stores the program for execution or download. In addition, the medium may be a variety of recording means or storage means having a single piece of hardware or a combination of several pieces of hardware, and is not limited to a medium that is directly connected to any computer system, and accordingly, may be present on a network in a distributed manner. An example of the medium includes a medium configured to store program instructions, including a magnetic medium such as a hard disk, a floppy disk, and a magnetic tape, an optical medium such as a CD-ROM and a DVD, a magnetic-optical medium such as a floptical disk, and a ROM, a RAM, a flash memory, and so on. In addition, other examples of the medium may include an app store that distributes applications, a site that supplies or distributes various software, and a recording medium or a storage medium managed by a server.

The methods, operations, or techniques of the present disclosure may be implemented by various means. For example, these techniques may be implemented in hardware, firmware, software, or a combination thereof. Those skilled in the art will further appreciate that various illustrative logical blocks, modules, circuits, and algorithm steps described in connection with the disclosure herein may be implemented in electronic hardware, computer software, or combinations of both. To clearly illustrate this interchangeability of hardware and software, various illustrative components, blocks, modules, circuits, and steps have been described above generally in terms of their functionality. Whether such a function is implemented as hardware or software varies depending on design requirements imposed on the particular application and the overall system. Those skilled in the art may implement the described functions in varying ways for each particular application, but such implementation should not be interpreted as causing a departure from the scope of the present disclosure.

In a hardware implementation, processing units used to perform the techniques may be implemented in one or more ASICs, DSPs, digital signal processing devices (DSPDs), programmable logic devices (PLDs), field programmable gate arrays (FPGAs), processors, controllers, microcontrollers, microprocessors, electronic devices, other electronic units designed to perform the functions described in the present disclosure, computer, or a combination thereof.

Accordingly, various example logic blocks, modules, and circuits described in connection with the present disclosure may be implemented or performed with general purpose processors, DSPs, ASICs, FPGAs or other programmable logic devices, discrete gate or transistor logic, discrete hardware components, or any combination of those designed to perform the functions described herein. The general purpose processor may be a microprocessor, but in the alternative, the processor may be any related processor, controller, microcontroller, or state machine. The processor may also be implemented as a combination of computing devices, for example, a DSP and microprocessor, a plurality of microprocessors, one or more microprocessors associated with a DSP core, or any other combination of the configurations.

In the implementation using firmware and/or software, the techniques may be implemented with instructions stored on a computer-readable medium, such as random access memory (RAM), read-only memory (ROM), non-volatile random access memory (NVRAM), programmable read-only memory (PROM), erasable programmable read-only memory (EPROM), electrically erasable PROM (EEPROM), flash memory, compact disc (CD), magnetic or marking data storage devices, etc. The instructions may be executable by one or more processors, and may cause the processor(s) to perform certain aspects of the functions described in the present disclosure.

If implemented in software, the techniques described above may be stored on a computer-readable medium as one or more instructions or codes, or may be sent via a computer-readable medium. The computer-readable media include both the computer storage media and the communication media including any medium that facilitates the transmission of a computer program from one place to another. The storage media may also be any available media that may be accessible to a computer. By way of non-limiting example, such a computer-readable medium may include RAM, ROM, EEPROM, CD-ROM or other optical disk storage, magnetic disk storage or other magnetic storage devices, or any other media that can be used to transmit or store desired program code in the form of instructions or data structures and can be accessible to a computer. In addition, any connection is properly referred to as a computer-readable medium.

For example, if the software is sent from a website, server, or other remote sources using coaxial cable, fiber optic cable, twisted pair, digital subscriber line (DSL), or wireless technologies such as infrared, wireless, and microwave, the coaxial cable, the fiber optic cable, the twisted pair, the digital subscriber line, or the wireless technologies such as infrared, wireless, and microwave are included within the definition of the medium. The disks and the discs used herein include CDs, laser disks, optical disks, digital versatile discs (DVDs), floppy disks, and Blu-ray disks, where disks usually magnetically reproduce data, while discs optically reproduce data using a laser. The combinations described above should also be included within the scope of the computer-readable media.

The software module may reside in RAM memory, flash memory, ROM memory, EPROM memory, EEPROM memory, registers, hard disk, removable disk, CD-ROM, or any other form of storage medium known. An exemplary storage medium may be connected to the processor, such that the processor may read or write information from or to the storage medium. Alternatively, the storage medium may be integrated into the processor. The processor and the storage medium may exist in the ASIC. The ASIC may exist in the user terminal. Alternatively, the processor and storage medium may exist as separate components in the user terminal.

Although the examples described above have been described as utilizing aspects of the currently disclosed subject matter in one or more standalone computer systems, aspects are not limited thereto, and may be implemented in conjunction with any computing environment, such as a network or distributed computing environment. Furthermore, the aspects of the subject matter in the present disclosure may be implemented in multiple processing chips or devices, and storage may be similarly influenced across a plurality of devices. Such devices may include PCs, network servers, and portable devices.

Although the present disclosure has been described in connection with some examples herein, various modifications and changes can be made without departing from the scope of the present disclosure, which can be understood by those skilled in the art to which the present disclosure pertains. In addition, such modifications and changes should be considered within the scope of the claims appended herein.

1. A method performed by one or more processors, the method comprising:
obtaining a trace from a source program configured to perform an artificial intelligence calculation, wherein the trace comprises at least one of:
a code associated with the source program; or
a primitive operation associated with the source program; and
generating, based on the trace, a call list comprising a plurality of primitive operations,
wherein the plurality of primitive operations are comprised in an operation library accessible to each of a plurality of accelerators.

2. The method according to claim 1, wherein the obtaining the trace comprises:
determining, by executing the source program, at least one of: the code or the primitive operation associated with the artificial intelligence calculation; and
obtaining the trace comprising the at least one of: the code or the primitive operation associated with the artificial intelligence calculation.

3. The method according to claim 1, wherein the generating the call list comprises:
determining a correlation for each of the plurality of primitive operations; and
generating the call list comprising the determined correlation for each of the plurality of primitive operations.

4. The method according to claim 3, wherein the correlation is associated with a relationship in which output data of a first primitive operation comprised in the call list is input to a second primitive operation comprised in the call list.

5. The method according to claim 1, wherein the generating the call list comprises:
generating, based on the plurality of primitive operations comprised in the call list, a graph representing a call order and a correlation of the plurality of primitive operations.

6. The method according to claim 1, further comprising transmitting the generated call list to at least one of the plurality of accelerators,
wherein the at least one of the plurality of accelerators is configured to, upon receiving the call list, access the operation library and call the plurality of primitive operations comprised in the call list.

7. The method according to claim 1, further comprising generating, by applying the call list to at least one compiler pass, a new call list.

8. The method according to claim 7, wherein the generating the new call list comprises:
based on identifiers of the plurality of primitive operations, determining, from among the plurality of primitive operations comprised in the call list, at least two primitive operations to be merged with each other;
merging the at least two primitive operations into one primitive operation; and
generating the new call list by changing the call list to comprise the merged primitive operation.

9. The method according to claim 8, wherein input data for each of the at least two primitive operations is input to the merged primitive operation.

10. The method according to claim 7, wherein the generating the new call list comprises:
determining a quantity of at least two accelerators to be provided with the call list;
dividing, based on the quantity of at least two accelerators, input data comprised in the call list; and
generating the new call list by changing the call list to comprise the divided input data.

11. The method according to claim 7, wherein the generating the new call list comprises:
determining a quantity of at least two accelerators to be provided with the call list;
dividing, based on the quantity of at least two accelerators, the call list into a plurality of sub call lists; and
generating the new call list by changing the call list such that the divided plurality of sub call lists are pipelined.

12. The method according to claim 11, further comprising:
after the generating the new call list, transmitting the divided plurality of sub call lists to the at least two accelerators, wherein the at least two accelerators comprise a first accelerator and a second accelerator, and
wherein a same node comprises:
the first accelerator that is configured to receive a first sub call list; and
the second accelerator that is configured to receive a second sub call list pipelined with the first sub call list.

13. The method according to claim 12, wherein the generating the new call list comprises inserting at least one command into at least one of the first sub call list or the second sub call list such that output data based on the first sub call list is provided as input data of a primitive operation included in the second sub call list.

14. The method according to claim 11, further comprising:
after the generating the new call list, transmitting the plurality of sub call lists to the at least two accelerators, wherein the at least two accelerators comprise a first accelerator and a second accelerator, and
wherein a first accelerator configured to receive a first sub call list is comprised in a first node, and a second accelerator configured to receive a second sub call list pipelined with the first sub call list is comprised in a second node, and the first node is a neighboring node adjacent to the second node.

15. The method according to claim 7, wherein the generating the new call list comprises:
determining a quantity of at least two accelerators to be provided with the call list;
dividing, based on the quantity of at least two accelerators, a plurality of parameters applied to each of the plurality of primitive operations comprised in the call list; and
generating a new call list by changing the call list to comprise the divided parameters.

16. The method according to claim 7, wherein the generating the new call list comprises:
determining, from among the plurality of primitive operations comprised in the call list, at least two primitive operations to be merged with each other, wherein the determining the at least two primitive operations is based on at least one of:
data structure associated with the plurality of primitive operations; or
identifiers associated with the plurality of primitive operations;
merging the at least two primitive operations into one primitive operation; and
generating the new call list by changing the call list to comprise the merged primitive operation.

17. The method according to claim 7, wherein the generating the new call list comprises:
identifying, from among the plurality of primitive operations comprised in the call list, at least one independently-performed primitive operation;
changing an execution order of the identified at least one independently-performed primitive operation; and
generating a new call list by changing the call list to comprise the at least one independently-performed primitive operation.

18. The method according to claim 17, wherein the changing the execution order comprises changing the execution order of the at least one independently-performed primitive operation such that the execution order of the identified at least one independently-performed primitive operation is advanced.

19. A non-transitory computer-readable medium storing instructions that, when executed, cause performance of the method of claim 1.

20. An information processing system, comprising:
one or more processors; and
memory storing instructions that, when executed by the one or more processors, cause the information processing system to:
obtain a trace from a source program configured to perform an artificial intelligence calculation, wherein the trace comprises at least one of:
a code associated with the source program; or
a primitive operation associated with the source program; and
generate, based on the trace, a call list comprising a plurality of primitive operations,
wherein the plurality of primitive operations are comprised in an operation library accessible to each of a plurality of accelerators.
